(19) United States
(12) Patent Application Publication
(10) Pub. No.: US 2011/0019222 A1
(43) Pub. Date: Jan. 27, 2011

(54) METHOD FOR MONITORING A PRINTER

(76) Inventors: Weng Sing Tang, Singapore (SG); Fu Wang Thio, Singapore (SG); Khanh Tung Vu, Singapore (SG)

Correspondence Address: JACOBSON HOLMAN PLLC, 400 SEVENTH STREET N.W., SUITE 600, WASHINGTON, DC, 20004, US

(21) Appl. No.: 12/934,776

(22) PCT Filed: Mar. 27, 2009
(86) PCT No.: PCT/SG2009/000106

§ 371 Date: Sep. 27, 2010

(30) Foreign Application Priority Data
Mar. 28, 2008 (SG) 200802455-6

(51) Int. Cl. G06F 3/12

(52) U.S. Cl. 358/1.14; 358/1.15

(57) ABSTRACT

A method is disclosed to monitor print job status. A list of available printers is determined, and network printers or local printers are determined. The printer status is queried before sending data to a printer. Meta-information is inserted into the print data to know when a document starts to print and when the document finishes printing. The printer is queried regarding status of the print job as well as printer status.

### FIELD OF THE INVENTION

This invention relates generally to monitoring a printing process of a document, and more particularly to obtaining print job status.

### BACKGROUND

The printing architecture of an operating system includes a user mode and a kernel mode. The user mode typically includes a users' application (optional) and a spooler. The spooler typically includes print monitors. The print monitors are responsible for directing a print data stream to corresponding port drivers. The connecting layer between the user mode and the kernel mode is usually an operating system graphics interface. A printer driver works at both the user mode and the kernel mode.

The spooler will perform some operations on the print job such as inserting page size information and page layout information, how the print job should be processed, etc. The spooler then sends the print data stream to printer's port. The printer translates the print data into a bitmap and prints the document.

With an operating system, the user usually desires to get the status of print job. However the existing systems often fall short of meeting the expectation of user.

In the context of the operating system, the user can view a list of printers as well as print jobs corresponding with each printer. However, the status of print jobs is usually a list of print queues and the status of spooling process. The operating system can only monitor the print job until the spooling process is finished. The status of the printer and print jobs are updated during the spooling process of the print job. In case the printer is not spooling, the operating system considers that the printer is ready.

Once, the print job data has been sent successfully to the printer, the operating system will not provide any additional information on how document is printed such as paper jam, printer malfunction, etc.

For a local printer, the operating system gives a specific ID for each print job. By querying the spooler, the user knows whether the spooling process is successful or not. However, in the case of networking printing, there is usually a remote spooler and the operating system does monitor the spooling process. Furthermore, success of the spooling process does not necessarily guarantee that the document has printed successfully.

There is a need for a method to monitor print job status in network printing. There is also a need for a method that monitors when the print job is started and when each page is printed successfully. There is a further need for a method that monitors hardware status relevant to the printer during the printing process such as out of paper, paper jam or opened printer door.

### SUMMARY

An aspect of the invention is a method of monitoring a printer comprises providing a print job for the printer, wherein the print job includes print data for printing a document, inserting meta-information into the print job, sending the print job to the printer, printing the document at the printer using the print data in the print job, identifying when the printer begins printing the document using the meta-information, and identifying when the printer finishes printing the document using the meta-information.

In an embodiment the method may include providing the print job in printer job language. The method may include providing the print job in response to a user, identifying to the user when the printer begins printing the document using the meta-information, and identifying to the user when the printer finishes printing the document using the meta-information. The method can also include inserting the meta-information into the print job independently of the user. The method can also include identifying to the user when the printer begins printing the document using a display screen, and identifying to the user when the printer finishes printing the document using the display screen. The method may include constructing the meta-information using a name of the document. The method may include inserting the meta-information into the print data for each page of the document, identifying when the printer begins printing each page of the document using the meta-information, and identifying when the printer finishes printing each page of the document using the meta-information. The meta-information can be inserted into the print data for each page of the document immediately after each separation mark for each page of the document. The method may include identifying when the printer begins printing the document using a first printer status message sent from the printer, and identifying when the printer finishes printing the document using a second printer status message sent from the printer. The first and second status messages can be sent from the printer using TCP/IP protocol. The method may include identifying when the printer begins printing the document without using the print data, and identifying when the printer finishes printing the document without using the print data. The method may include inserting page size and page layout of the document into the print job. The method may include identifying when the printer lacks paper, the printer jams, and/or the printer has an open door, after the printer begins printing the document and before the printer finishes printing the document. The method may include sending a first status inquiry to the printer, identifying when the printer begins printing the document in response to the first status inquiry, sending a second status inquiry to the printer, and identifying when the printer finishes printing the document in response to the second status inquiry. The method may include providing a bidirectional transmission link that is coupled to the printer, sending the print job to the printer using the transmission link, identifying when the printer begins printing the document using the transmission link, and identifying when the printer finishes printing the document using the transmission link. The transmission link can use TCP/IP protocol and include the Internet and/or a USB cable. The method may include providing a network that includes network printers, wherein the network printers include the printer, identifying available printers from the network printers, selecting the printer from the available printers, and providing the print job for the printer in response to selecting the printer.

### BRIEF DESCRIPTION OF THE DRAWINGS

In order that embodiments of the invention may be fully and more clearly understood by way of non-limitative examples, the following description is taken in conjunction with the accompanying drawings in which like reference numerals designate similar or corresponding elements, regions and portions, and in which:

FIG. 1 illustrates obtaining printer information and getting printer identity in respect of the operating system according to an embodiment of the invention;

FIG. 2 illustrates a hand-shake method with the printer according to an embodiment of the invention;

FIG. 3 illustrates processing print data to insert meta-information according to an embodiment of the invention; and

FIG. 4 illustrates printing and monitoring the printer and print job status according to an embodiment of the invention.

### DETAILED DESCRIPTION

A method is disclosed to monitor print job status. A list of available printers is determined, and network printers are determined. The printer status is queried before sending data to a printer. Meta-information is inserted into the print data to know when a document starts to print and when the document finishes printing. The printer is queried regarding status of the print job as well as printer status. In particular, an embodiment of the invention is a method to monitor a print job from when the print job is sent out of the operating system until it is printed successfully or failure.

In an embodiment, the method prints directly to the printer and bypass the printing process of the operating system. Hence the system can be extended to run on multiple-platforms. The user is informed when the first page of the document starts to print and when the last page of the document is printed successfully. The user is also informed of which page number is printed and which page number has a problem in printing.

In an embodiment, printer status is forwarded to the user during the printing process. The method uses TCP/IP protocol to get print status in network printing and use kernel mode APIs to communicate with a local printer. During the monitoring process, the printing channel between the printer and the computer is held so that the method has full control of the printing process.

The method first discovers all connected printers and lets the user select the desired printer. Using operating system APIs, the method determines information about the selected printer such as whether the printer is a network printer, the printer network address, the printer server name, and the like. Then the method establishes a printing connection with a printer to send print data to the printer.

Analyzing the print data (printing stream data), the method inserts meta-information into the print data. For each page of the print data, the method inserts meta-information, and therefore it can query the printer on the status of the printing process for each page, as well as for the whole document.

An embodiment uses a bidirectional printer which provides bidirectional communication. The printer supports printer job language such as printer command language (PCL), printer job language (PJL), printer control language (PCL), and the like so that the print job can be set with the meta-information. PCL is a registered trademark of Hewlett-Packard Company of California, United States of America. The operating system queries printer information. It will be appreciated any operating system may be used. For example, the WINDOWS operating system has a native method to query printer information. WINDOWS is a registered trademark of Microsoft of Washington, United States of America.

An embodiment makes use of an operating system API to get printer information. The method to get the print job status involves the following stages:

Stage 1 (obtaining printer information): Determine a list of printers and which printer is a network printer or local printer. When the user selects the printer, the method analyzes data to get the printer identity from the operating system.

Stage 2 (hand-shake process with printer): The method queries on printer status before sending the input stream of data.

Stage 3 (process document): The method gets print data from the user. Then, the method inserts meta-information into the print data. The method also analyzes the document and inserts the meta-information into each page of the document.

Stage 4 (printing and monitoring printer status): The printing connection is open from stage 2, and then the print data is sent as a data stream to the printer directly instead of passing through the operating system process. The method listens to the printing channel to get the printing status. A message return from the printer such as printer status as well as print job is displayed to the user.

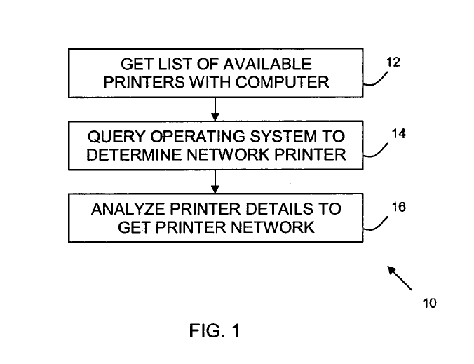

FIG. 1 illustrates an embodiment of a method 10 to get printer information. Each box represents an action or an executable module. Step 12 obtains a list of available printers with the current computer. Step 14 determines whether the printer is a network printer or local printer by obtaining printer information from the operating system.

The printer port and printer monitor are also obtained using the operating system APIs. For example, in a WINDOWS operating system, the printer information is obtained from APIs PRINTER_INFO_{—}2 and PORT_INFO_{—}2. The step 16 will analyze the data returned by the operating system APIs to get printer identity. For example, if printer is a network printer, the network address of the printer is returned. If the printer is a local printer and the operating system is WINDOWS, the GUID of the printer is returned. After the printer identity and printer type are determined, the user will be able to proceed printing with the identified printer, otherwise an error message is returned to the user.

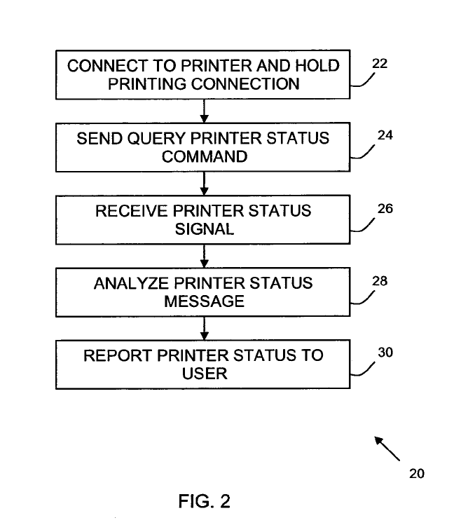

The FIG. 2 illustrates a hand shake phase 20 to ensure that the printer is ready to accept the print job before streaming the print data to the printer.

At step 22, the method connects to the printer and holds the printing connection. Step 24 queries the printer on the printer status. Step 24 sends print language commands to query about the current status of the printer such as whether the printer supports PJL, and uses PJL command USTATUS to enable unsolicited printer status.

In case the method receives a signal from the printer 26, it analyzes the returned messages 28 to confirm that the printer is ready to accept a new print job.

Printer status messages are received through some specific channel such as TCP/IP protocol in network printing or native call in local printing. The printer status is provided and notified to the user 30.

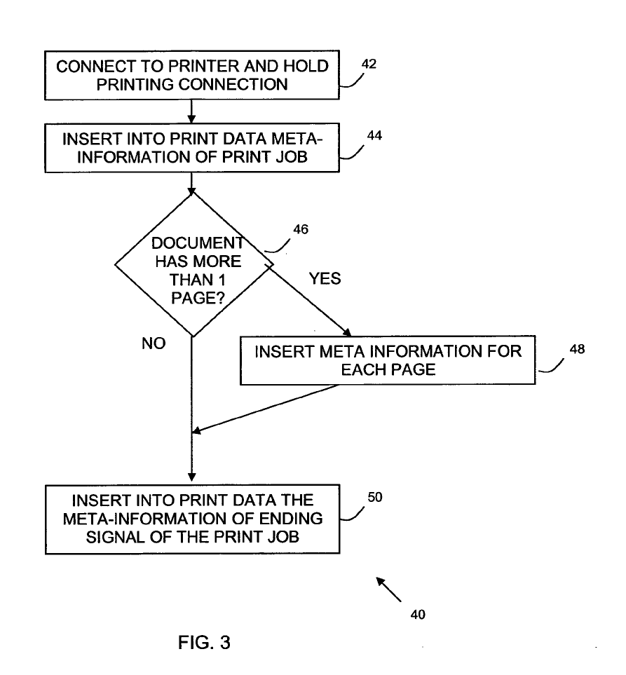

FIG. 3 illustrates an embodiment of a method 40 of processing a document by adding meta-information of into print stream; usually the meta-information consists of printer supported print language commands. Step 42 gets the document from the user. The method inserts into the print data the meta-information of the print job 44. The document name which is obtained from step 42 is used as one component to construct the meta-information.

Step 46 analyzes the print data of the document to determine number of pages. If the document has more than 1 page, then step 48 inserts the meta-information for each page into the print data right after each separation mark of each page. Hence when each page is finished printing, the user can keep track of each page due to the meta-information for each page.

In case the document has only 1 page, the method jumps from step 46 directly to step 50. Step 50 inserts into the print data the meta-information of ending signal for print job. This is done by using printer job language. For example, in case of printers supporting PJL, step 50 can use the PJL command EOJ NAME.

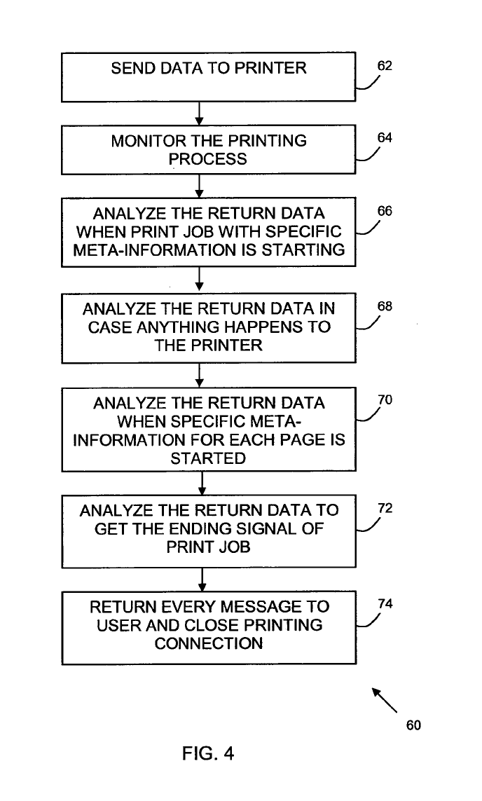

FIG. 4 illustrates an embodiment of a method 60 to gather the printer status. Step 62 sends the print data after processing directly to the printer. Step 62 bypasses the operating system printing system.

The method listens to changes at the printer 64. Step 66 monitors the printer and notifies the user when the print job with the meta-information starts. During printing, if the printer encounters a problem such as a paper jam, being out of paper, or an open printer door, the status is displayed to the user 68.

Step 70 analyzes the returned data to check whether the meta-information for each page is returned or not. Furthermore in conjunction with the returned printer status data from step 68, the method reports which page has the printer problem. For example, the document has 3 pages to print. At step 70, the application has received the meta-information of page 1 and page 2. However, it has not received the meta-information for page 3, and instead receives the status of printer jam. The application concludes that printer jam occurred during printing of page 3.

Step 72 analyzes the returned data to get the ending meta-information of the print job. When the method receives the ending meta-information of the print job, it concludes that all pages are printed successfully. The status messages are returned to the user and the method releases the printing connection 74.

The invention may be applied and extended into different forms and applications, for example to provide a print monitoring job in the printing service industry, integrate with customer generic applications to do printing and monitor print jobs implemented as a web base application to control users printing from the Internet, and the like. The invention may be extended to local printer applications. The invention may communicate directly with a parallel or USB port and bypass the operating system. The invention may be further extended to a wide range of local printers coupled to a mini printer server. The printer server can convert a parallel or USB port to a TCP/IP port and the method can monitor the status of a print job in network printing. The invention may be applied to different fields, for example a self-service printing business, a printing kiosk, a printing counter, remote printing, enterprise network printing, quota printing, and the like.

While embodiments of the invention have been described and illustrated, it will be understood by those skilled in the technology concerned that many variations or modifications in details of design or construction may be made without departing from the present invention.

1. A method of monitoring a printer, comprising:
providing a print job for the printer, wherein the print job includes print data for printing a document;
inserting meta-information into the print job;
sending the print job to the printer;
printing the document at the printer using the print data in the print job;
identifying when the printer begins printing the document using the meta-information; and
identifying when the printer finishes printing the document using the meta-information.

2. The method of claim 1, further comprising providing the print job in printer job language.

3. The method of claim 1 or 2, further comprising:
providing the print job in response to a user;
identifying to the user when the printer begins printing the document using the meta-information; and
identifying to the user when the printer finishes printing the document using the meta-information.

4. The method of claim 3, further comprising inserting the meta-information into the print job independently of the user.

5. The method of claim 3, further comprising:
identifying to the user when the printer begins printing the document using a display screen; and
identifying to the user when the printer finishes printing the document using the display screen.

6. The method of any one of the preceding claims, further comprising constructing the meta-information using a name of the document.

7. The method of any one of the preceding claims, further comprising:
inserting the meta-information into the print data for each page of the document; and
identifying when the printer finishes printing each page of the document using the meta-information.

8. The method of any one of the preceding claims, further comprising:
inserting the meta-information into the print data for each page of the document immediately after each separation mark for each page of the document; and
identifying when the printer finishes printing each page of the document using the meta-information.

9. The method of any one of the preceding claims, further comprising:
inserting the meta-information into the print data for each page of the document;
identifying when the printer begins printing each page of the document using the meta-information; and
identifying when the printer finishes printing each page of the document using the meta-information.

10. The method any one of the preceding claims, further comprising:
identifying when the printer begins printing the document using a first printer status message sent from the printer; and
identifying when the printer finishes printing the document using a second printer status message sent from the printer.

11. The method of claim 10, further comprising sending the first and second status messages from the printer using TCP/IP protocol.

12. The method of any one of the preceding claims, further comprising:
identifying when the printer begins printing the document without using the print data; and
identifying when the printer finishes printing the document without using the print data.

13. The method of any one of the preceding claims, further comprising inserting page size and page layout of the document into the print job.

14. The method of any one of the preceding claims, further comprising identifying when the printer lacks paper after the printer begins printing the document and before the printer finishes printing the document.

15. The method of any one of the preceding claims, further comprising identifying when the printer jams after the printer begins printing the document and before the printer finishes printing the document.

16. The method of any one of the preceding claims, further comprising identifying when the printer has an open door after the printer begins printing the document and before the printer finishes printing the document.

17. The method of any one of the preceding claims, further comprising:
sending a first status inquiry to the printer;
identifying when the printer begins printing the document in response to the first status inquiry;
sending a second status inquiry to the printer; and
identifying when the printer finishes printing the document in response to the second status inquiry.

18. The method of any one of the preceding claims, further comprising:
providing a bidirectional transmission link that is coupled to the printer;
sending the print job to the printer using the transmission link;
identifying when the printer begins printing the document using the transmission link; and
identifying when the printer finishes printing the document using the transmission link.

19. The method of claim 18, wherein the transmission link includes a USB cable.

20. The method of any one of the preceding claims, further comprising:
providing a network that includes network printers, wherein the network printers include the printer;
identifying available printers from the network printers;
selecting the printer from the available printers; and
providing the print job for the printer in response to selecting the printer.

21. A method of monitoring a printer, comprising:
providing a display screen that interfaces with a user;
providing a print job for the printer in response to the user, wherein the print job includes print data for printing a document and is in printer job language; then
inserting meta-information into the print job independently of the user; then
sending the print job across a transmission link to the printer; then
printing the document at the printer using the print data in the print job;
identifying to the user when the printer begins printing the document using the meta-information, the transmission link and the display screen; and
identifying to the user when the printer finishes printing the document using the meta-information the transmission link and the display screen.

22. The method of claim 21, including:
inserting the meta-information into the print data for each page of the document; and
identifying to the user when the printer finishes printing each page of the document using the meta-information, the transmission link and the display screen.

23. The method of claim 22, including the meta-information into the print data for each page of the document immediately after each separation mark for each page of the document.

24. The method of claim 22, including identifying to the user when the printer begins printing each page of the document using the meta-information, the transmission link and the display screen.

25. The method of any one of claims 21-24, including:
sending a first status inquiry to the printer using the transmission link;
identifying to the user when the printer begins printing the document using a first printer status message sent from the printer to the user using the transmission link in response to the first status inquiry;
sending a second status inquiry to the printer using the transmission link; and
identifying when the printer finishes printing the document using a second printer status message sent from the printer to the user using the transmission link in response to the second status inquiry.

26. The method of any one of claims 21-25, including:
identifying to the user when the printer begins printing the document without using the print data; and
identifying to the user when the printer finishes printing the document without using the print data.

27. The method of any one of claims 21-26, including:
identifying to the user when the printer lacks paper after the printer begins printing the document and before the printer finishes printing the document using the transmission link and the display screen;
identifying to the user when the printer jams after the printer begins printing the document and before the printer finishes printing the document using the transmission link and the display screen; and
identifying to the user when the printer has an open door after the printer begins printing the document and before the printer finishes printing the document using the transmission link and the display screen.

28. The method of any one of claims 21-27, wherein the transmission link uses TCP/IP protocol.

29. The method of any one of claims 21-28, wherein the transmission link includes the Internet.

30. The method of any one of claims 21-29, wherein the transmission link includes a USB cable.

31. A method of monitoring a printer in a network that includes network printers and a display screen that interfaces with a user, comprising:
identifying available printers from the network printers;
selecting the printer from the available printers in response to the user;
providing a print job for the printer in response to the user, wherein the print job includes print data for printing a document and is in printer job language; then
inserting meta-information into the print job independently of the user; then
sending the print job across a transmission link to the printer; then
printing the document at the printer using the print data in the print job;
identifying to the user when the printer begins printing the document using the meta-information, the transmission link and the display screen; and
identifying to the user when the printer finishes printing the document using the meta-information the transmission link and the display screen.

32. The method of claim 31, including:
inserting the meta-information into the print data for each page of the document; and
identifying to the user when the printer finishes printing each page of the document using the meta-information, the transmission link and the display screen.

33. The method of claim 32, including the meta-information into the print data for each page of the document immediately after each separation mark for each page of the document.

34. The method of claim 32, including identifying to the user when the printer begins printing each page of the document using the meta-information, the transmission link and the display screen.

35. The method of any one of claims 31-34, including:
sending a first status inquiry to the printer using the transmission link;
identifying to the user when the printer begins printing the document using a first printer status message sent from the printer to the user using the transmission link in response to the first status inquiry;
sending a second status inquiry to the printer using the transmission link; and
identifying when the printer finishes printing the document using a second printer status message sent from the printer to the user using the transmission link in response to the second status inquiry.

36. The method of any one of claims 31-35, including:
identifying to the user when the printer begins printing the document without using the print data; and
identifying to the user when the printer finishes printing the document without using the print data.

37. The method of any one of claims 31-36, including:
identifying to the user when the printer lacks paper after the printer begins printing the document and before the printer finishes printing the document using the transmission link and the display screen;
identifying to the user when the printer jams after the printer begins printing the document and before the printer finishes printing the document using the transmission link and the display screen; and
identifying to the user when the printer has an open door after the printer begins printing the document and before the printer finishes printing the document using the transmission link and the display screen.

38. The method of any one of claims 31-37, wherein the transmission link uses TCP/IP protocol.

39. The method of any one of claims 31-38, wherein the transmission link includes the Internet.

40. The method of claim 31, wherein the transmission link includes a USB cable.
